(19) United States
(12) Patent Application Publication
(10) Pub. No.: US 2011/0299896 A1
(43) Pub. Date: Dec. 8, 2011

(54) OIL APPLICATION ROLLER, FIXING APPARATUS AND IMAGE FORMING APPARATUS

(76) Inventor: Kenji KITAMI, Osaka (JP)

(21) Appl. No.: 13/151,874

(22) Filed: Jun. 2, 2011

(30) Foreign Application Priority Data
Jun. 8, 2010 (JP) 2010-131209

(51) Int. Cl. G03G 15/20

(52) U.S. Cl. 399/325

(57) ABSTRACT

In one embodiment, an oil application roller contacts a surface of a fixing rotary member of a fixing apparatus, and applies oil to the surface of the fixing rotary member. A porous sheet is wrapped around a peripheral surface of a cylindrical member, and an end portion on a wrapping start side of the porous sheet is inclined relative to a rotation shaft of the oil application roller.

### CROSS-REFERENCE TO RELATED APPLICATIONS

This application claims priority under 35 U.S.C. §119(a) on Patent Application No. 2010-131209 filed in Japan on Jun. 8, 2010, the entire contents of which are herein incorporated by reference.

### BACKGROUND OF THE INVENTION

The present invention relates to an oil application roller that contacts the surface of a fixing rotary member of a fixing apparatus to apply oil to the surface, a fixing apparatus using such an oil application roller, and an image forming apparatus provided with such a fixing apparatus.

Conventionally, a fixing apparatus has been applied to image forming apparatuses employing a xerography method, electrostatic recording method, magnetophotographic method or the like. With this type of fixing apparatus, recording paper (e.g., plain paper, electrostatic recording paper, and photo paper) to which a toner image has been transferred is held between a pair of fixing rotary members (e.g., belt and roller), and heated and pressed, thereby fixing the toner image on the recording paper.

With such a fixing apparatus, in order to prevent toner on the recording paper from adhering to the surface of the fixing rotary member, an oil application roller is caused to contact the surface of the fixing rotary member to apply oil thereto.

For example, an oil application roller 101 shown in FIG. 16 is formed by wrapping a porous sheet 103 several times around the peripheral surface of a porous cylindrical member 102 impregnated with oil. The oil application roller 101 contacts a fixing roller (that is, a fixing rotary member) 104, and applies oil to the surface of the fixing roller 104 while being driven and rotated by the fixing roller 104.

JP 2000-284627A (“Patent Document 1”) discloses a configuration in which a gap between the wrapping start edge and the wrapping end edge of a sheet is set to be smaller than the contact width between the oil application roller and the fixing rotary member, thereby suppressing fluctuation in the oil application amount.

Also, JP 2009-300700A (“Patent Document 2”) discloses a configuration employing an oil application roller in which a sheet is wrapped around at least once, and the wrapping end edge of the sheet is wrapped over and bonded to the peripheral surface of the sheet lying under the wrapping end edge.

In the example of either Patent Document 1 or 2, the wrapping start edge of the sheet of the oil application roller is cut parallel to the shaft of the oil application roller. In such a case, as shown in FIG. 17, a wrapping start edge 103a of the sheet 103 forms a step 105 that is parallel to the shaft of the oil application roller 101 on the peripheral surface of the oil application roller 101.

This step 105 may be caught by the surface of the fixing roller 104, and generates a large resistance for the rotative driving of the oil application roller 101. Therefore, the fixing roller 104 may slide on the surface of the oil application roller 101 and cannot climb over the step 105, or the rotative driving of the oil application roller 101 may be stopped. Also, the surface of the oil application roller 101 and the surface of the fixing roller 104 may be wet with oil, or paper dust may be adhered to the surface of the oil application roller 101. For this reason, frictional resistance generated between the oil application roller 101 and the fixing roller 104 is small, and thus if there is even a small obstacle such as a step 105 in the oil application roller 101, the resistance caused by the step 105 becomes larger than the frictional resistance, which may become a cause for stopping the rotative driving of the oil application roller 101.

If the fixing roller 104 slides on the surface of the oil application roller 101 and fails to clime over the step 105, so that the oil application roller 101 stops being rotatively driven, toner adhered to the surface of the fixing roller 104 accumulates in the step 105 of the oil application roller 101. Then, when the fixing apparatus stops operation, toner accumulated in the step 105 of the oil application roller 101 is cooled and becomes a lump. When the fixing apparatus is re-activated and rotation of the fixing roller 104 is started again, the toner lump accumulated in the step 105 of the oil application roller 101 may damage the surface of the fixing roller 104.

On the other hand, if, for example, the contact pressure applied by the oil application roller 101 against the fixing roller 104 is increased, then the frictional resistance between the oil application roller 101 and the fixing roller 104 increases, so that the oil application roller 101 is kept to be rotatively driven.

However, when the contact pressure applied by the oil application roller 101 is increased, the amount of oil pushed out of the cylindrical member 102 of the oil application roller 101 increases. Then, the service life of the oil application roller 101 is shortened, the rotation load to the fixing roller 104 increases, and the fixing roller 104 will be damaged.

### SUMMARY OF THE INVENTION

The present invention has been made in view of the conventional issues as described above, and it is an object thereof to provide an oil application roller capable of reliably preventing the oil application roller from stopping being rotatively driven without increasing contact pressure applied by the oil application roller, a fixing apparatus using such an oil application roller, and an image forming apparatus provided with such a fixing apparatus.

In order to solve the above-described issues, an oil application roller comprising a cylindrical member impregnated with oil, and a porous sheet wrapped around a peripheral surface of the cylindrical member, and being configured to be in contact with a surface of a fixing rotary member of a fixing apparatus to apply the oil to the surface of the fixing rotary member, wherein an edge on a wrapping start side of the porous sheet has a shape formed by being cut in a straight line or a curved line that is inclined relative to a rotation shaft of the oil application roller.

With the oil application roller of the present invention, since the edge on the wrapping start side of the porous sheet is inclined relative to the rotation shaft of the oil application roller, the step formed by the edge on the wrapping start side of the porous sheet on the peripheral surface of the oil application roller is also inclined relative to the rotation shaft. Therefore, the oil application roller contacts the fixing rotary member and is rotatively driven, and when the step due to the edge on the wrapping start side of the porous sheet passes between the oil application roller and the fixing rotary member, the contact width of the step to the fixing rotary member is narrow at first, and is gradually widened. At every rotation of the oil application roller, the step repeats passing between the oil application roller and the pressure roller as described above.

Since the contact width of the step is narrow at first, and resistance caused by the step having a narrow width is small, fixing rotary member can easily climb over the narrow-width step of the oil application roller, and the oil application roller 21 is kept to be rotatively driven. Also, once the fixing rotary member climbs over the step, the oil application roller is kept to be rotatively driven even though the contact width of the step of the oil application roller to the fixing rotary member is widened. Therefore, the oil application roller continues to be rotatively driven.

Also, with the oil application roller of the present invention, it is preferable that there are a plurality of said straight or curved lines, intersecting each other.

In such a case, the edge on the wrapping start side of the porous sheet on the peripheral surface of the oil application roller is formed to have a chevron shape or a sawtooth shape. The contact width of the step of the oil application roller to the fixing rotary member at first is also narrow, and thus the fixing rotary member easily climbs over the narrow-width step, and the oil application roller continues to be rotatively driven.

An oil application roller of the present invention is an oil application roller comprising a cylindrical member impregnated with oil, and a porous sheet wrapped around a peripheral surface of the cylindrical member, and being configured to be in contact with a surface of a fixing rotary member of a fixing apparatus to apply the oil to the surface of the fixing rotary member, and it is preferable that the width of the porous sheet is gradually narrowed toward an end portion on a wrapping start side of the porous sheet.

With such an oil application roller of the present invention as well, the contact width of the step of the oil application roller to the fixing rotary member is narrow at first, and is gradually widened with the rotation of the oil application roller. Therefore, the fixing rotary member easily climbs over the narrow-width step, and the oil application roller is kept to be rotatively driven.

Also, with the oil application roller of the present invention, it is preferable that the width of the porous sheet is gradually narrowed such that the end portion on the wrapping start side of the porous sheet is formed in a triangle or a trapezoid shape.

Furthermore, with the oil application roller of the present invention, it is preferable that the porous sheet is wrapped around the peripheral surface of the cylindrical member a number of times corresponding to an integer of two or more, and the shape of an edge on the wrapping start side of the porous sheet is such that on the peripheral surface of the cylindrical member, the edge on the wrapping start side and an edge on a wrapping end side of the porous sheet are adjacent to and parallel to each other, without mutually overlapping.

In the case where the edge on the wrapping start side and the edge on the wrapping end side of the porous sheet are adjacent to and parallel to each other, without mutually overlapping, as described above, on the peripheral surface of the oil application roller, a step projecting out at the edge on the wrapping start side is formed, and an edge on the wrapping end side is fitted into the projecting step, thereby eliminating the projection caused by the step.

Also, in a fixing apparatus of the present invention, the oil application roller of the invention contacts a surface of a fixing rotary member. Also with such a fixing apparatus, an effect similar to the oil application roller of the present invention can be achieved.

Also, an image forming apparatus of the present invention includes the fixing apparatus of the present invention. Also with such an image forming apparatus, an effect similar to the oil application roller of the present invention can be achieved.

### BRIEF DESCRIPTION OF THE DRAWINGS

FIG. 1 is a cross-sectional view of an image forming apparatus to which a fixing apparatus according to an embodiment of the present invention is applied.

FIG. 2 is a cross-sectional view of the fixing apparatus of the embodiment.

FIG. 3 is a cross-sectional view showing an enlarged view of a pressure roller, an oil application roller and a backup roller of the fixing apparatus shown in FIG. 2.

FIG. 4 is a plan view showing the wrapping start side of a sheet in the oil application roller shown in FIG. 3.

FIG. 5 is a plan view of the oil application roller, the pressure roller, and the backup roller.

FIG. 6 is a cross-sectional view illustrating a state in which the step in the oil, application roller is in contact with the backup roller.

FIG. 7 is a table showing results of a test for checking occurrence of a rotation failure with respect to the oil application roller in the fixing apparatus shown in FIG. 2 and the conventional oil application roller shown in FIGS. 16 and 17.

FIG. 8 is a plan view of a first modified example of the sheet of the oil application roller.

FIG. 9 is a plan view of a second modified example of the sheet of the oil application roller.

FIG. 10 is a plan view of a third modified example of the sheet of the oil application roller.

FIG. 11 is a plan view of a fourth modified example of the sheet of the oil application roller.

FIG. 12 is plan view of a fifth modified example of the sheet of the oil application roller.

FIG. 13 is a plan view of a sixth modified example of the sheet of the oil application roller.

FIG. 14 is a plan view of a seventh modified example of the sheet of the oil application roller.

FIG. 15A is a cross-sectional view of an oil application roller in which a sheet of the seventh modified example is wrapped around the peripheral surface of a cylindrical member.

FIG. 15B is a plan view of an oil application roller in which a sheet of the seventh modified example is wrapped around the peripheral surface of a cylindrical member.

FIG. 16 is a cross-sectional view schematically showing a conventional oil application roller.

FIG. 17 is a plan view schematically showing a conventional oil application roller.

### DESCRIPTION OF THE PREFERRED EMBODIMENTS

Hereinafter, embodiments of the present invention will be described based on the accompanying drawings. Note that the below embodiments are only examples of the present invention, and are not of a nature limiting the technical scope of the present invention.

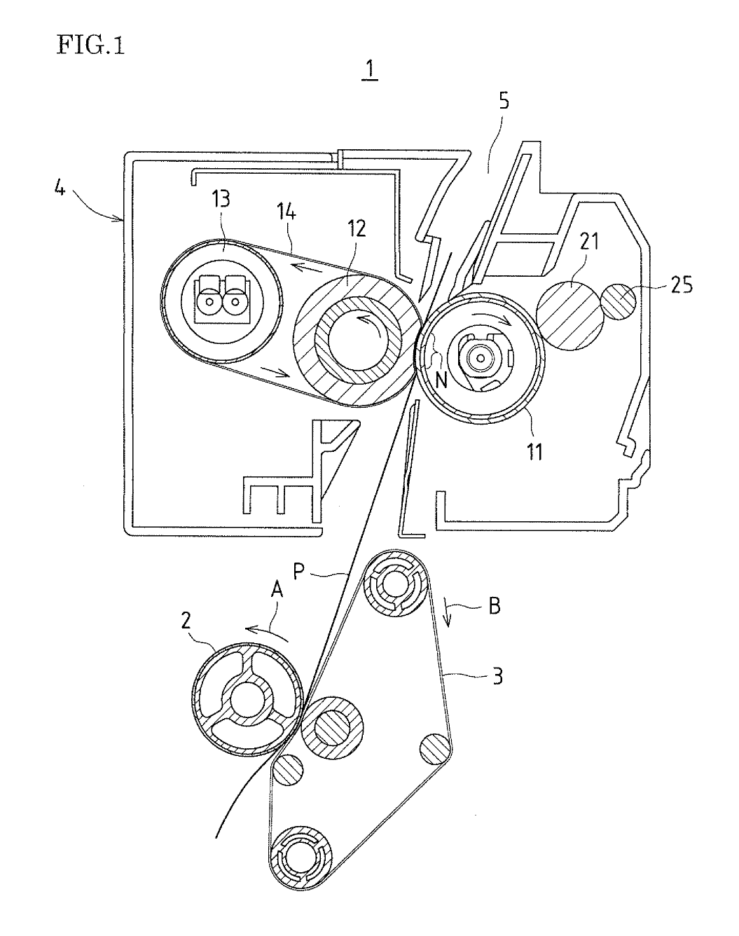

FIG. 1 is an enlarged cross-sectional view of a main portion of an image forming apparatus to which a fixing apparatus according to an embodiment of the present invention is applied. The image forming apparatus 1 is based on xerography, and includes a photosensitive drum 2, a transfer belt 3, a fixing apparatus 4, and the like. The photosensitive drum 2 includes a photosensitive layer on its surface, and is rotationally driven in the direction of arrow A at a constant rotation speed. As the photosensitive drum 2 rotates, the surface of the photosensitive drum 2 is evenly charged to a predetermined potential with a charging device (not shown in the drawings), the surface of the photosensitive drum 2 is exposed with an exposure device (not shown in the drawings), an electrostatic latent image is formed on the surface, and the electrostatic latent image on the surface of the photosensitive drum 2 is developed into a toner image with the developing device (not shown in the drawings).

The transfer belt 3 is circumferentially driven in the direction of arrow B at the same speed as the surface speed of the photosensitive drum 2, and is pressed against the photosensitive drum 2, thereby forming a nip region between the transfer belt 3 and the photosensitive drum 2. Recording paper P that has been transported from below the nip region is introduced to the nip region, and while the recording paper P is transported in the nip region, the toner image on the surface of the photosensitive drum 2 is transferred to the recording paper P. In order to transfer the toner images, a high-voltage transfer bias (a high voltage of the opposite polarity (+) to the charge polarity (−) of the toner) is applied to the transfer belt 3.

The recording paper P is transported upward and guided to the fixing apparatus 4, where heat and pressure are applied to the recording paper P so as to fix the toner image on the recording paper P. The recording paper P is further transported upward via a transport path 5, and is discharged to a discharge tray (not shown in the drawings) or the like.

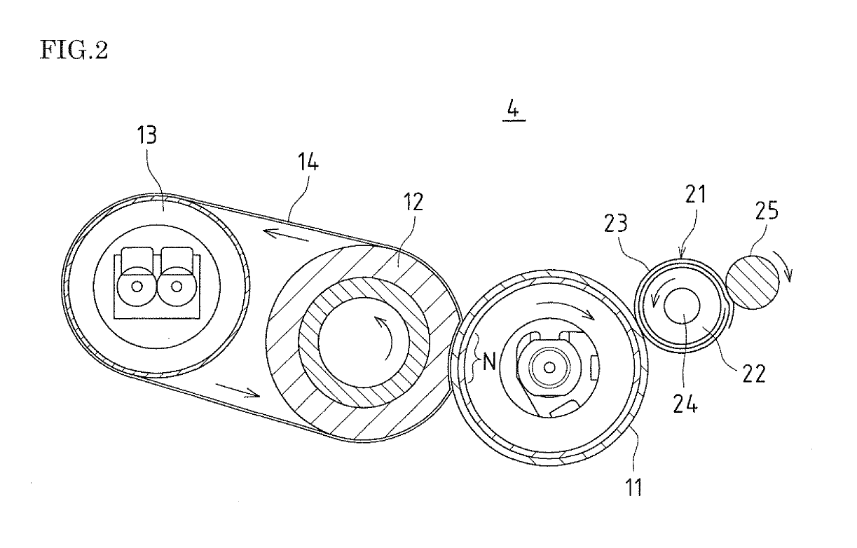

FIG. 2 is a cross-sectional view of the fixing apparatus 4 of the present embodiment. As shown in FIG. 2, the fixing apparatus 4 includes a pressure roller 11, a fixing roller 12, a heating assistant roller 13, and an endless fixing belt 14 stretched over the fixing roller 12 and the heating assistant roller 13, and the pressure roller 11 and the fixing roller 12 are pressed against each other with the fixing belt 14 interposed therebetween, thereby forming a nip region N between the fixing belt 14 and the pressure roller 11.

The pressure roller 11 has a three-layer structure, which is formed by providing an elastic layer on the outer surface of a hollow shaft, and forming a separation layer on the outer surface of the elastic layer. A heater lamp (halogen lamp) that serves as a heater source for heating the roller 11 is provided inside the pressure roller 11 (inside the hollow shaft).

The fixing roller 12 is formed by providing an elastic layer on the outer surface of a hollow shaft, the elastic layer having a sufficient thickness.

The fixing belt 14 is an endless belt made from a material having good heat conduction, and includes a separation layer on its outer peripheral surface.

The heating assistant roller 13 is formed by providing a surface layer on the outer surface of a hollow shaft, and a heater lamp (halogen lamp) that serves as a heater source for heating the roller 13 is provided inside the heating assistant roller 13 (inside the hollow shaft).

Here, since the elastic layer of the fixing roller 12 has a sufficient thickness, when the pressure roller 11 and the fixing roller 12 press against each other with the fixing belt 14 interposed therebetween, the elastic layer of the fixing roller 12 is largely dented so that a wide nip region N is formed between the fixing belt 14 and the pressure roller 11. As a result of the rollers 11, 12 and 13 being rotated in the directions of the corresponding arrows, the fixing belt 14 circumferentially moves via the nip region N while it is heated by the heating assistant roller 13. If a recording paper is transported via the nip region N in this state, the recording paper is heated and pressed by the fixing belt 14 and the pressure roller 11, and the toner image on the recording paper is fixed.

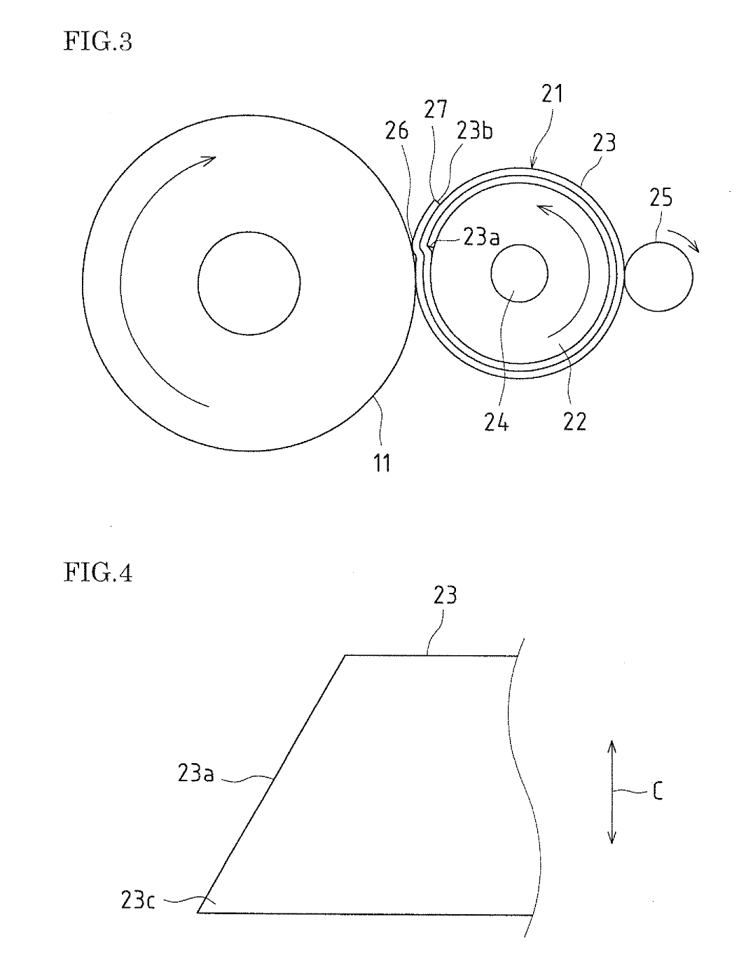

On the other side, the fixing apparatus 4 includes an oil application roller 21 pressed against the pressure roller 11, and a backup roller 25 pressed against the oil application roller 21. FIG. 3 is a cross-sectional view schematically illustrating the pressure roller 11, the oil application roller 21, and the backup roller 25. As shown in FIG. 3, the oil application roller 21 includes a porous cylindrical member 22, a porous sheet 23 wrapped several times around the peripheral surface of the cylindrical member 22, and a shaft 24 that is passed through the center of the cylindrical member 22 and rotatably supports the cylindrical member 22.

The porous cylindrical member 22 is made of sponge-like synthetic resin, and impregnated with silicone oil or the like. The porous sheet 23 is a porous PTFE (polytetrafluoroethylene) sheet. The sheet 23 is wrapped one to three times around the peripheral surface of the cylindrical member 22, and a wrapping end portion of the sheet 23 is laser-welded to a portion in the peripheral surface of the sheet 23 that lies under the wrapping end portion. Note that thermal compression bonding or adhesive agent may be used instead of laser welding.

The oil application roller 21 is pressed against the surface of the pressure roller 11, and rotatively driven by the pressure roller 11. At this time, oil is supplied in small amounts to the surface of the pressure roller 11 from the porous cylindrical member 22 via the porous sheet 23, such that oil is applied to the surface of the pressure roller 11. Accordingly, it becomes difficult for toner to adhere to the surface of the pressure roller 11 to which oil has been applied.

Also, the backup roller 25 is pressed against the oil application roller 21. The backup roller 25 is provided for removing toner that has been transferred from the surface of the pressure roller 11 to the surface of the oil application roller 21.

Here, even with a thin sheet 23, a step 26 appears in the peripheral surface of the cylindrical member 22 at a position above an edge 23a on the wrapping start side of the sheet 23, and a step 27 appears at a position corresponding to an edge 23b on the wrapping end side.

Also, as apparent from FIG. 3, the oil application roller 21 is rotatively driven in a direction opposite to the wrapping direction of the sheet 23. This is because if the oil application roller 21 is rotatively driven in the wrapping direction of the sheet 23, the step 27 due to the edge 23b on the wrapping end side repeatedly abuts the pressure roller 11, and the edge 23b on the wrapping end side rises and is peeled off.

As a result of the oil application roller 21 being rotatively driven in the direction opposite to the wrapping direction of the sheet 23 as shown in FIG. 3, the step 26 due to the edge 23a on the wrapping start side reaches the location between the oil application roller 21 and the pressure roller 11, and the pressure roller 11 climbs over the step 26. Then, the step 27 due to the edge 23b on the wrapping end side reaches the location between the rollers 21 and 11, and the pressure roller 11 climbs down the step 27.

For this reason, when the oil application roller 21 is rotatively driven, although the step 26 due to the edge 23a on the wrapping start side acts as a resistance, the step 27 due to the edge 23b on the wrapping end side does not act as a resistance.

Also when the step 26 due to the edge 23a on the wrapping start side reaches the location between the oil application roller 21 and the backup roller 25, the backup roller 25 climbs over the step 26, and thus the step 26 due to the edge 23a on the wrapping start side acts as a resistance.

In view of these issues, the present embodiment reduces resistance caused by the step 26 due to the edge 23a on the wrapping start side when the oil application roller 21 is rotatively driven.

FIG. 4 is a plan view showing the wrapping start side of the sheet 23. When the shaft 24 of the oil application roller 21 extends in a longitudinal direction C as shown in FIG. 4, the edge 23a on the wrapping start side of the sheet 23 has a shape formed by being cut in a straight line that is inclined relative to the longitudinal direction C of the shaft 24. In other words, the width of the sheet 23 is gradually narrowed toward an end portion 23c on the wrapping start side, such that the end portion 23c on the wrapping start side has a triangle shape.

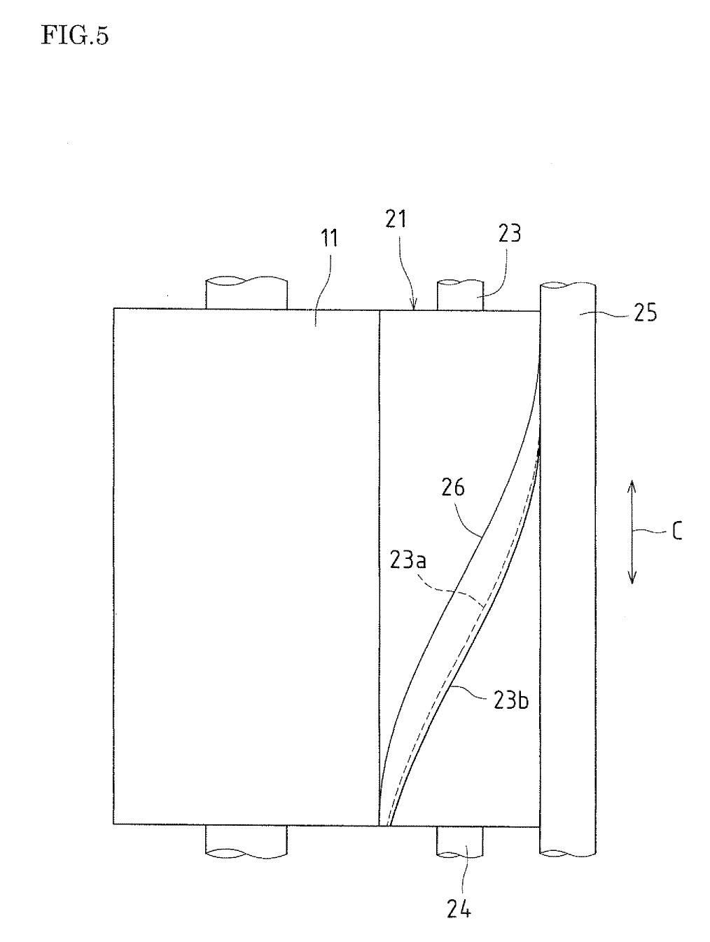

FIG. 5 is a plan view of the oil application roller 21, the pressure roller 11 and the backup roller 25. As shown in FIG. 5, on the peripheral surface of the oil application roller 21, the edge 23a on the wrapping start side of the sheet 23 is inclined relative to the longitudinal direction C of the shaft 24, and therefore the step 26 due to the edge 23a on the wrapping start side is also inclined relative to the longitudinal direction C of the shaft 24.

Therefore, when the step 26 due to the edge 23a on the wrapping start side passes between the oil application roller 21 and the pressure roller 11 as the oil application roller 21 is rotatively driven, the contact width of the step 26 to the pressure roller 11 is narrow at first, and then gradually widened. At every rotation of the oil application roller 21, the step 26 repeats passing between the oil application roller 21 and the pressure roller 11 as described above.

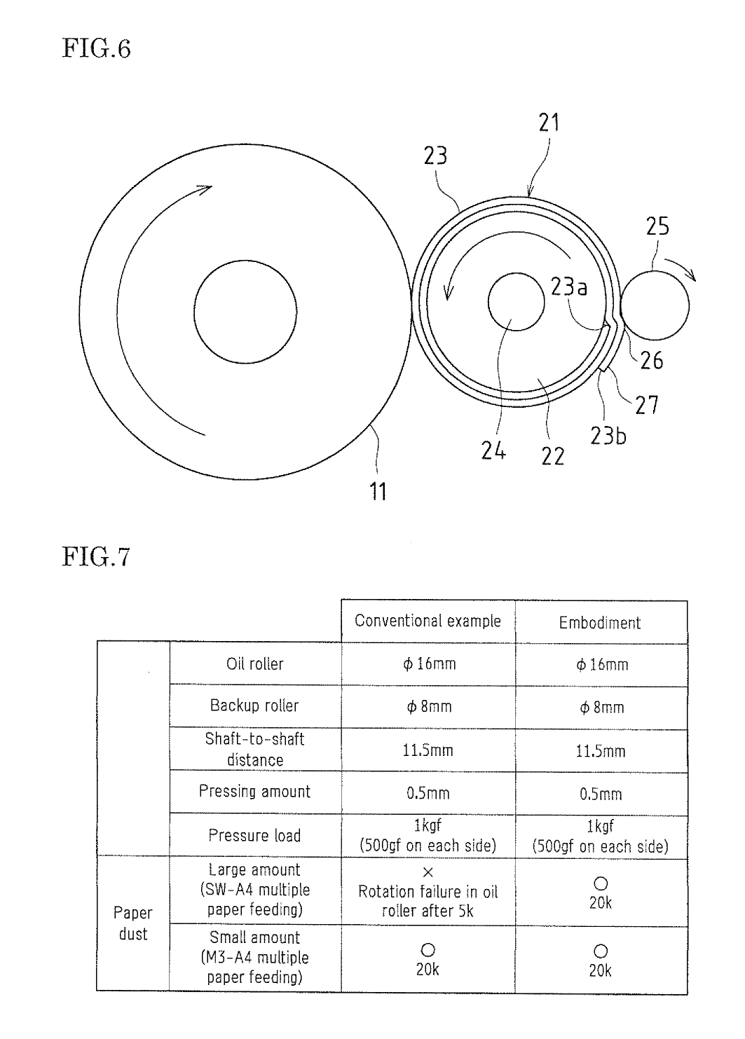

Also when the step 26 due to the edge 23a on the wrapping start side passes between the oil application roller 21 and the backup roller 25 as shown in FIG. 6, the contact width of the step 26 to the backup roller 25 is narrow at first, and then gradually widened. At every rotation of the oil application roller 21, the step 26 repeats passing between the oil application roller 21 and the backup roller 25 as described above.

As described above, since the contact width of the step 26 is narrow at first, and the resistance caused by the narrow-width step 26 is small, the pressure roller 11 and the backup roller 25 can easily climb over the narrow-width step 26. Also, once the oil application roller 21 climbs over the step 26, the oil application roller 21 is kept to be rotatively driven even though the contact width of the step 26 of the oil application roller 21 to the pressure roller 11 and the backup roller 25 is widened. Therefore, the oil application roller 21 continues to be rotatively driven.

That is, as a result of the edge 23a on the wrapping start side of the sheet 23 being inclined relative to the longitudinal direction C of the shaft 24, or as a result of the end portion 23c on the wrapping start side of the sheet 23 being formed to have a triangle shape, the contact width of the step 26 to the pressure roller 11 and the backup roller 25 is made narrow at first, and thus the pressure roller 11 and the backup roller 25 can easily climb over the narrow-width step 26, so that the oil application roller 21 continues to be rotatively driven.

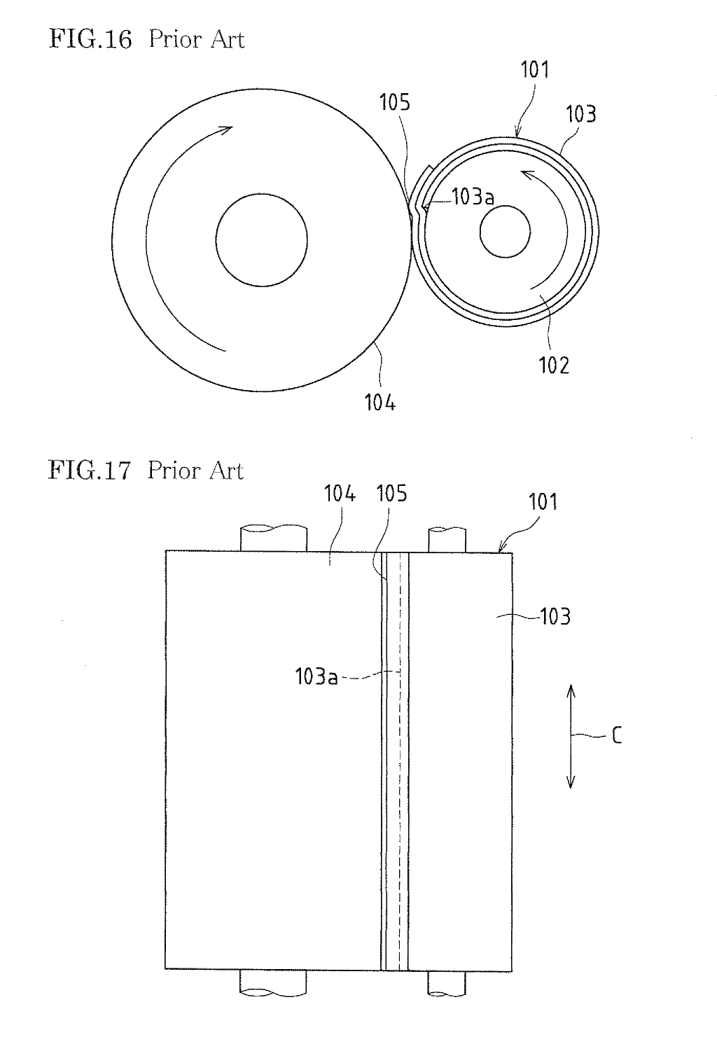

FIG. 7 is a table showing results of a test for checking the occurrence of a rotation failure with respect to the oil application roller 21 in the fixing apparatus 4 of the present embodiment and the conventional oil application roller 101 shown in FIGS. 16 and 17.

In the conventional oil application roller 101, the wrapping start edge 103a of the sheet 103 is cut parallel to the shaft of the oil application roller 101, and due to the wrapping start edge 103a, the step 105 is formed parallel to the shaft of the oil application roller 101.

In the test, the diameters of the oil application rollers 21 and 101 were set to 16 mm, and the diameter of the backup roller 25 was set to 8 mm, the shaft-to-shaft distance between the oil application roller 21 and the backup roller 25 and that between the oil application roller 101 and the backup roller 25 were set to 11.5 mm (pressing amount by the backup roller 25 against the oil application rollers 21 and 101 is assumed to be 0.5. mm), and the contact pressure between the oil application roller 21 and the pressure roller 11 and that between the oil application roller 101 and the pressure roller 11 were set to 1 kgf.

Then, fixing processing by the fixing apparatus 4 was continuously performed by feeding multiple sheets of recording paper “SW-A4”, which produces a large amount of paper dust, and recording paper “M3-A4”, which produces a small amount of paper dust, and the rotation condition of the oil application rollers 21 and 101 was checked after finishing fixing processing for 5,000 (5 k) sheets and 20,000 (20 k) sheets. The test was performed for two types of recording paper which produce different amounts of paper dust because, as the amount of produced paper dust increases, the amount of paper dust that adheres to the peripheral surface of the oil application rollers 21 and 101 increases, and the oil application rollers 21 and 101 are readily caused to stop (SW-A4 and M3-A4 are recording paper recommended by Sharp Corporation).

As clearly understood from the table in FIG. 7, with the conventional oil application roller 101, the oil application roller 101 stopped operation after processing 5,000 (5 k) sheets of recording paper SW-A4, which produces a large amount of paper dust, whereas the oil application roller 101 did not stop operation even after processing 20,000 (20 k) sheets of recording paper M3-A4, which produces a small amount of paper dust.

In contrast, the oil application roller 21 of the present embodiment did not stop operation after processing 20,000 (20 k) sheets of recording paper, for both of recording paper SW-A4, which produces a large amount of paper dust, and recording paper M3-A4, which produces a small amount of paper dust.

Accordingly, it is possible to state that stoppage of operation is less likely in the oil application roller 21 of the present embodiment than in the conventional oil application roller 101. This is because the resistance generated when the pressure roller 11 and the backup roller 25 climb over the narrow-width step in the oil application roller 21 of the present embodiment is smaller than the resistance generated when the pressure roller 11 and the backup roller 25 climb over the conventional step parallel to the shaft of the oil application roller 101.

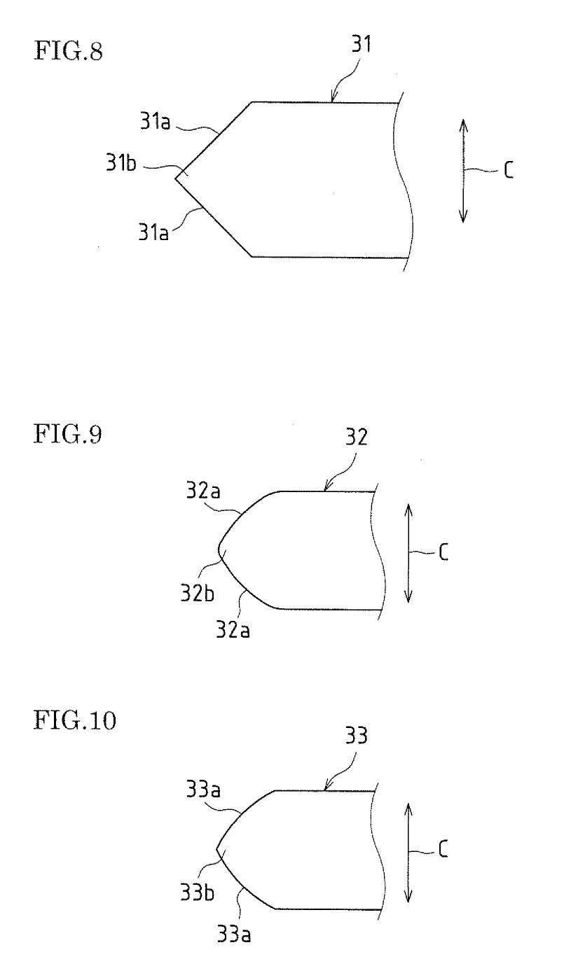

FIG. 8 is a plan view showing a first modified example of a sheet wrapped around the peripheral surface of the cylindrical member 22 of the oil application roller 21. With a sheet 31 of the first modified example, an edge 31a on the wrapping start side has a triangle shape formed by being cut along two straight lines that are inclined relative to the longitudinal direction C of the shaft 24 and intersect each other. In other words, the width of the sheet 31 is gradually narrowed toward an end portion 31b of the wrapping start side, such that the end portion 31b on the wrapping start side has a triangle shape.

Also in the case where this sheet 31 is wrapped around the peripheral surface of the cylindrical member 22, when the step due to the edge 31a on the wrapping start side passes between the oil application roller 21 and the pressure roller 11 (or the backup roller 25) as the oil application roller 21 is rotatively driven, the contact width of the step to the pressure roller 11 (or the backup roller 25) is narrow at first, and then gradually widened. Therefore, the pressure roller 11 (or the backup roller 25) can easily climb over the narrow-width step, and the oil application roller 21 is kept to be rotatively driven.

FIG. 9 is a plan view of a second modified example of the sheet wrapped around the peripheral surface of the cylindrical member 22 of the oil application roller 21. With a sheet 32 of the second modified example, an edge 32a on the wrapping start side has a shape formed by being cut in a curved line that is inclined relative to the longitudinal direction C of the shaft 24. In other words, the width of the sheet 32 is gradually narrowed toward an end portion 32b of the wrapping start side, such that the end portion 32b on the wrapping start side has a triangle shape.

FIG. 10 is a plan view of a third modified example of the sheet wrapped around the peripheral surface of the cylindrical member 22 of the oil application roller 21. With a sheet 33 of the third modified example, an edge 33a on the wrapping start side has a shape formed by being cut along two curved lines that are inclined relative to the longitudinal direction C of the shaft 24 and intersect each other. In other words, the width of the sheet 33 is gradually narrowed toward an end portion 33b of the wrapping start side, such that the end portion 33b on the wrapping start side has a triangle shape.

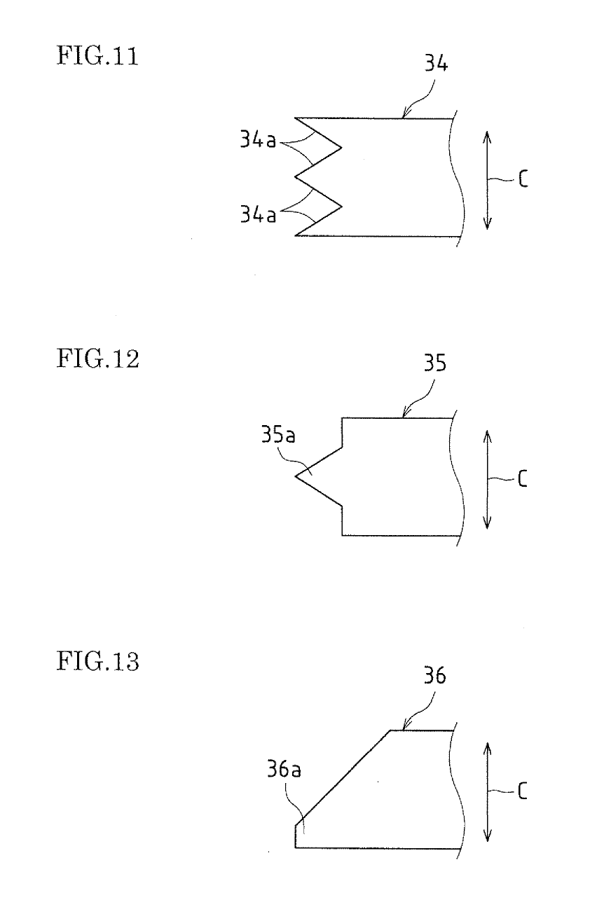

FIG. 11 is a plan view of a fourth modified example of the sheet wrapped around the peripheral surface of the cylindrical member 22 of the oil application roller 21. With a sheet 34 of the fourth modified example, an edge 34a on the wrapping start side has a chevron shape or a sawtooth shape formed by being cut along a plurality of straight lines that are inclined relative to the longitudinal direction C of the shaft 24 and intersect each other.

FIG. 12 is a plan view of a fifth modified example of the sheet wrapped around the peripheral surface of the cylindrical member 22 of the oil application roller 21. With a sheet 35 of the fifth modified example, the width of the sheet 35 is gradually narrowed toward an end portion 35a of the wrapping start side, such that the end portion 35a on the wrapping start side has a triangle shape.

FIG. 13 is a plan view of a sixth modified example of the sheet wrapped around the peripheral surface of the cylindrical member 22 of the oil application roller 21. With a sheet 36 of the sixth modified example, the width of the sheet 36 is gradually narrowed toward an end portion 36a of the wrapping start side, such that the end portion 36a on the wrapping start side has a trapezoid shape.

Also in the case where the sheets 32 to 35 of the second to sixth modified examples are wrapped around the peripheral surface of the cylindrical member 22, as the oil application roller 21 is rotatively driven, the contact width of the step to the pressure roller 11 (or the backup roller 25) is narrow at first, and then gradually widened. Therefore, the pressure roller 11 (or the backup roller 25) can easily climb over the narrow-width step, and the oil application roller 21 is kept to be rotatively driven.

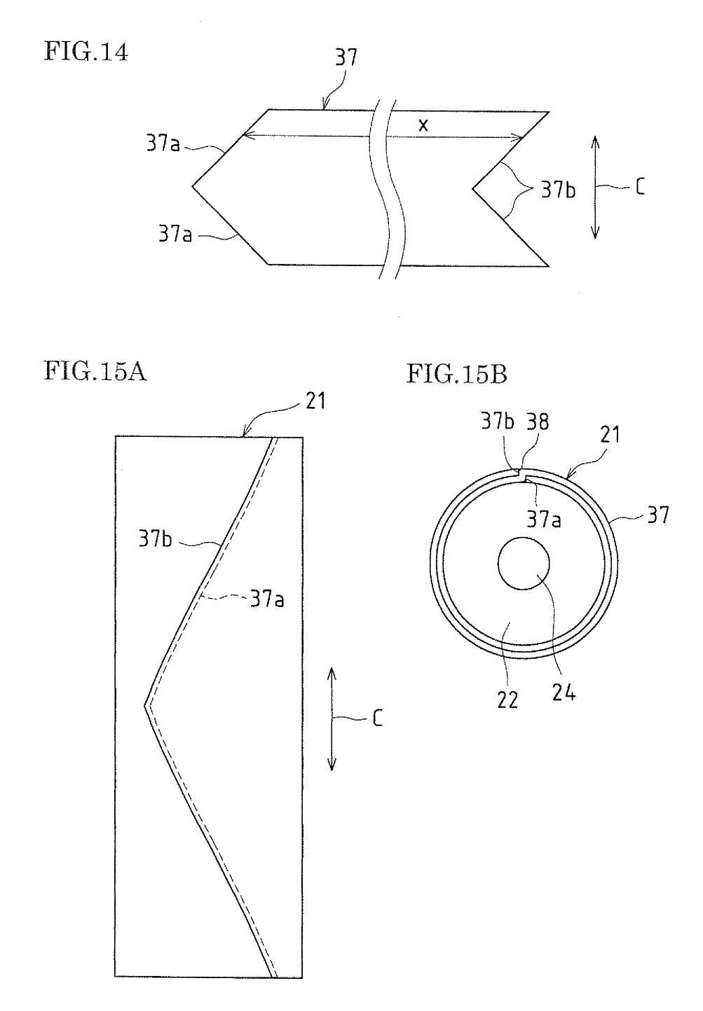

FIG. 14 is a plan view of a seventh modified example of the sheet wrapped around the peripheral surface of the cylindrical member 22 of the oil application roller 21. Also, FIGS. 15A and 15B are, respectively, a cross-sectional view and a plan view of the oil application roller 21 in which the sheet of the seventh modified example is wrapped around the peripheral surface of the cylindrical member 22.

Similar to the sheet 31 in FIG. 8, an edge 37a on the wrapping start side of a sheet 37 of the seventh modified example has a triangle shape formed by being cut along two straight lines that are inclined relative to the longitudinal direction C of the shaft 24 and intersect each other. Also, an edge 37b on the wrapping end side has a triangular recessed portion that fits into an edge 37a on the wrapping start side. In the case where the edge 37b on the wrapping end side has a shape that fits into the edge 37a on the wrapping start side, an advantage can be achieved that no waste is produced when cutting out a plurality of sheets 37 from a sheet material.

If x is the length from the edge 37a on the wrapping start side to the edge 37b on the wrapping end side, along the direction orthogonal to the longitudinal direction C of the shaft 24, the length x is constant regardless of the position in the longitudinal direction C of the shaft 24, and can be set to a length that is an integer multiple (of at least 2 times) of the length of the peripheral surface of the cylindrical member 22. Therefore, it is possible to wrap the sheet 37 around the peripheral surface of the cylindrical member 22 at least twice.

Also, when the sheet 37 is wrapped around the peripheral surface of the cylindrical member 22 as shown in FIGS. 15A and 15B, the edge 37a on the wrapping start side and the edge 37b on the wrapping end side of the sheet 37 are adjacent to and parallel to each other without mutually overlapping, on the peripheral surface of the cylindrical member 22. In such a case, a step 38 that projects out at the edge 37a on the wrapping start side is formed in the peripheral surface of the oil application roller 21, and the edge 37b on the wrapping end side fits into the projecting step 38, thereby eliminating the projection caused by the step 38. As a result, no large step is formed on the peripheral surface of the oil application roller 21, and the oil application roller 21 reliably continues to be rotatively driven.

The present invention may be embodied in various other forms without departing from the spirit or essential characteristics thereof. The embodiments disclosed in this application are to be considered in all respects as illustrative and not limiting. The scope of the invention is indicated by the appended claims rather than by the foregoing description, and all modifications or changes that come within the meaning and range of equivalency of the claims are intended to be embraced therein.

1. An oil application roller comprising a cylindrical member impregnated with oil, and a porous sheet wrapped around a peripheral surface of the cylindrical member, and being configured to be in contact with a surface of a fixing rotary member of a fixing apparatus to apply the oil to the surface of the fixing rotary member,
wherein an edge on a wrapping start side of the porous sheet has a shape formed by being cut in a straight line or a curved line that is inclined relative to a rotation shaft of the oil application roller.

2. The oil application roller according to claim 1,
wherein there are a plurality of said straight or curved lines, intersecting each other.

3. An oil application roller comprising a cylindrical member impregnated with oil, and a porous sheet wrapped around a peripheral surface of the cylindrical member, and being configured to be in contact with a surface of a fixing rotary member of a fixing apparatus to apply the oil to the surface of the fixing rotary member,
wherein the width of the porous sheet is gradually narrowed toward an end portion on a wrapping start side of the porous sheet.

4. The oil application roller according to claim 3,
wherein the width of the porous sheet is gradually narrowed such that the end portion on the wrapping start side of the porous sheet is formed in a triangle or a trapezoid shape.

5. The oil application roller according to claim 1,
wherein the porous sheet is wrapped around the peripheral surface of the cylindrical member a number of times corresponding to an integer of two or more, and
the shape of an edge on the wrapping start side of the porous sheet is such that on the peripheral surface of the cylindrical member, the edge on the wrapping start side and an edge on a wrapping end side of the porous sheet are adjacent to and parallel to each other, without mutually overlapping.

6. A fixing apparatus in which the oil application roller according to claim 1 contacts a surface of a fixing rotary member.

7. An image forming apparatus comprising the fixing apparatus according to claim 6.

8. A fixing apparatus in which the oil application roller according to claim 5 contacts a surface of a fixing rotary member.

9. An image forming apparatus comprising the fixing apparatus according to claim 8.
